(19) United States
(12) Patent Application Publication
(10) Pub. No.: US 2022/0274442 A1
(43) Pub. Date: Sep. 1, 2022

(54) INNER LINER, LAYERED BODY, AND PNEUMATIC TIRE

(71) Applicant: THE YOKOHAMA RUBBER CO., LTD., Tokyo (JP)

(72) Inventors: Shun SATO, Kanagawa (JP); Shusaku TOMOI, Kanagawa (JP)

(21) Appl. No.: 17/637,878

(22) PCT Filed: Aug. 24, 2020
(86) PCT No.: PCT/JP2020/031880

§ 371 Date: Feb. 24, 2022

(30) Foreign Application Priority Data
Aug. 30, 2019 (JP) 2019-158320

(51) Int. Cl. B60C 1/00; B60C 5/14; C08L 21/00; C08L 9/00

(52) U.S. Cl. CPC B60C 1/0008; B60C 5/14; C08L 21/00; C08L 9/00; C08L 2207/04

(57) ABSTRACT

Provided is an inner liner which adheres to the carcass or other rubber composition layer of a tire, even during low-temperature vulcanization on the order of 160° C., without using an adhesive or an adhesive tie gum. The invention provides a pneumatic tire inner liner comprising a thermoplastic elastomer composition, characterized in that the thermoplastic elastomer composition includes a thermoplastic resin (a11) having a melting point of 180° C. or lower, or a thermoplastic elastomer (a12) having a melting point of 180° C. or lower and including no residue containing an unsaturated bond derived from a conjugated diene compound, and an elastomer (a2) including a residue containing an unsaturated bond derived from a conjugated diene compound, and the tensile elongation at break of the thermoplastic elastomer composition at 25° C. temperature and 500 mm/min pull speed is 100% or greater.

### FIELD

The present invention relates to an inner liner, a laminate, and a pneumatic tire. More specifically, the present invention relates to an inner liner for a pneumatic tire comprising a thermoplastic elastomer composition, a laminate of a layer of a thermoplastic elastomer composition and a layer of a rubber composition, and a pneumatic tire comprising the inner liner or the laminate.

### BACKGROUND

Reducing the fuel consumption rate is one of the major technical issues in automobiles, and as part of this measure, there is a demand to reduce the weight of pneumatic tires. The inner surface of a pneumatic tire is provided with an inner liner composed of low gas permeable rubber, such as butyl rubber, to maintain the tire pressure at a constant level, and a technique of making the pneumatic tire lighter by forming the inner liner with a thermoplastic resin film to make the inner liner thinner is known. However, since a thermoplastic resin film does not easily bond to a layer of a rubber composition constituting a tire, an adhesive or an adhesive tie-rubber is used to bond them together. However, the use of an adhesive or an adhesive tie-rubber increases the manufacturing cost and adds the weight of the adhesive or the adhesive tie-rubber to the tire. Therefore, there is a need for an inner liner that can be easily bonded to a layer of a rubber composition constituting a tire, for example, a carcass, without using an adhesive or an adhesive tie-rubber.

For example, Japanese Unexamined Patent Publication No. H9-314752 (Patent Literature 1) discloses the use of a film of a thermoplastic elastomer composition comprising a polyamide resin and a brominated isobutylene-p-methylstyrene copolymer, and further comprising an epoxidized product of a block copolymer composed of a vinyl aromatic compound and a conjugated diene compound and/or a partially hydrogenated product thereof in the polyamide resin as an inner liner.

### CITATION LIST

### Patent Literature

[Patent Literature 1] Japanese Unexamined Patent Publication No. H9-314752

### SUMMARY

### Technical Problem

Typical tires are vulcanized at a temperature of about 180° C., whereas fuel-efficient tires, racing tires, or the like are vulcanized at a lower temperature (for example, 160° C.) than typical tire vulcanization in some cases.

A film of the thermoplastic elastomer composition described in Patent Literature 1 hardly bonds to a layer of a rubber composition constituting a tire when vulcanized at a low temperature of about 160° C.

The present invention is to provide an inner liner that is bonded to a layer of a rubber composition constituting a tire, such as a carcass, without using an adhesive or an adhesive tie-rubber, even when vulcanized at a low temperature of about 160° C.

### Solution to Problem

The present invention (I) is an inner liner for a pneumatic tire comprising a thermoplastic elastomer composition, wherein the thermoplastic elastomer composition comprises: a thermoplastic resin (a11) having a melting point of not higher than 180° C. or a thermoplastic elastomer (a12) which has a melting point of not higher than 180° C. and does not comprise a residue containing an unsaturated bond derived from a conjugated diene compound; and an elastomer (a2) comprising a residue containing an unsaturated bond derived from a conjugated diene compound, and wherein the thermoplastic elastomer composition has a tensile elongation at break at a temperature of 25° C. and a pull speed of 500 mm/min of not less than 100%.

The present invention (II) is a laminate of a layer of a thermoplastic elastomer composition and a layer of a rubber composition, wherein the thermoplastic elastomer composition comprises: a thermoplastic resin (a11) having a melting point of not higher than 180° C. or a thermoplastic elastomer (a12) which has a melting point of not higher than 180° C. and does not comprise a residue containing an unsaturated bond derived from a conjugated diene compound; and an elastomer (a2) comprising a residue containing an unsaturated bond derived from a conjugated diene compound, wherein the thermoplastic elastomer composition has a tensile elongation at break at a temperature of 25° C. and a pull speed of 500 mm/min of not less than 100%, and wherein the rubber composition comprises more than 50% by volume of a diene rubber, and the layer of the thermoplastic elastomer composition and the layer of the rubber composition are adjacent to each other.

The present invention (III) is a pneumatic tire comprising the inner liner of the present invention (I) or the laminate of the present invention (II).

The present invention includes the following embodiments.

[1] An inner liner for a pneumatic tire comprising a thermoplastic elastomer composition, wherein the thermoplastic elastomer composition comprises: a thermoplastic resin (a11) having a melting point of not higher than 180° C. or a thermoplastic elastomer (a12) which has a melting point of not higher than 180° C. and does not comprise a residue containing an unsaturated bond derived from a conjugated diene compound; and an elastomer (a2) comprising a residue containing an unsaturated bond derived from a conjugated diene compound, and wherein the thermoplastic elastomer composition has a tensile elongation at break at a temperature of 25° C. and a pull speed of 500 mm/min of not less than 100%.

[2] The inner liner according to [1], wherein the thermoplastic resin (a11) having a melting point of not higher than 180° C. or the thermoplastic elastomer (a12) which has a melting point of not higher than 180° C. and does not comprise a residue containing an unsaturated bond derived from a conjugated diene compound is at least one selected from the group consisting of a vinyl alcohol resin, an ethylene-vinyl acetate copolymer, a poly(vinyl acetate), a polyester elastomer, and a polyamide elastomer.

[3] The inner liner according to [1] or [2], wherein the elastomer (a2) comprising a residue containing an unsaturated bond derived from a conjugated diene compound is a copolymer of a vinyl aromatic compound having an acid anhydride group or epoxy group and a conjugated diene compound, or a partially hydrogenated product of the copolymer.

[4] The inner liner according to any one of [1] to [3], wherein the thermoplastic elastomer composition further comprises at least 2% by volume, based on the total amount of all polymer components in the thermoplastic elastomer composition, of a thermoplastic resin (a13) having a melting point of not lower than 200° C. or a thermoplastic elastomer (a14) which has a melting point of not lower than 200° C. and does not comprise a residue containing an unsaturated bond derived from a conjugated diene compound.

[5] The inner liner according to any one of [1] to [4], wherein the content of the thermoplastic resin (a11) having a melting point of not higher than 180° C., or the thermoplastic elastomer (a12) which has a melting point of not higher than 180° C. and does not comprise a residue containing an unsaturated bond derived from a conjugated diene compound is from 20 to 70% by volume based on the total amount of all polymer components in the thermoplastic elastomer composition, and the content of the elastomer (a2) comprising a residue containing an unsaturated bond derived from a conjugated diene compound is from 30 to 80% by volume based on the total amount of all polymer components in the thermoplastic elastomer composition.

[6] The inner liner according to any one of [1] to [5], wherein the elastomer (a2) comprising a residue containing an unsaturated bond derived from a conjugated diene compound is exposed on the surface of the inner liner, and the ratio of the exposed area is not less than 5% of the surface area of the inner liner.

[7] A laminate of a layer of a thermoplastic elastomer composition and a layer of a rubber composition, wherein the thermoplastic elastomer composition comprises: a thermoplastic resin (a11) having a melting point of not higher than 180° C. or a thermoplastic elastomer (a12) which has a melting point of not higher than 180° C. and does not comprise a residue containing an unsaturated bond derived from a conjugated diene compound; and an elastomer (a2) comprising a residue containing an unsaturated bond derived from a conjugated diene compound, wherein the thermoplastic elastomer composition has a tensile elongation at break at a temperature of 25° C. and a pull speed of 500 mm/min of not less than 100%, and wherein the rubber composition comprises not less than 50% by volume of a diene rubber, and the layer of the thermoplastic elastomer composition and the layer of the rubber composition are adjacent to each other.

[8] The laminate according to [7], wherein the diene rubber is at least one selected from the group consisting of a natural rubber, an isoprene rubber, a butadiene rubber, a styrene-butadiene rubber, a chioroprene rubber, and an acrylonitrile butadiene rubber.

[9] The laminate according to [7] or [8], wherein at the interface between the layer of the thermoplastic elastomer composition and the layer of the rubber composition, the elastomer (a2) comprising a residue containing an unsaturated bond derived from a conjugated diene compound in the layer of the thermoplastic elastomer composition is in contact with the layer of the rubber composition, and the ratio of the contact area is not less than 5% of the total contact area of the layer of the thermoplastic elastomer composition and the layer of the rubber composition.

[10] A pneumatic tire comprising the inner liner according to any one of [1] to [6] or the laminate according to any one of [7] to [9].

### Advantageous Effects of Invention

The inner liner according to the present invention can be bonded to a layer of a rubber composition constituting a tire, such as a carcass, without using an adhesive or an adhesive tie-rubber, even when vulcanized at a low temperature of about 160° C.

### DESCRIPTION OF EMBODIMENTS

The present invention (I) relates to an inner liner for a pneumatic tire. The inner liner is an air-permeation prevention layer provided on the inner surface of the tire to prevent air leakage in place of a tube in tubeless tires.

The inner liner comprises a thermoplastic elastomer composition.

The thermoplastic elastomer composition comprises: a thermoplastic resin (a11) having a melting point of not higher than 180° C. or a thermoplastic elastomer (a12) which has a melting point of not higher than 180° C. and does not comprise a residue containing an unsaturated bond derived from a conjugated diene compound.

A thermoplastic resin (a11) having a melting point of not higher than 180° C. (hereinafter, simply referred to as “thermoplastic resin (a11)”) is preferably, but not limited to, a vinyl alcohol resin, an ethylene-vinyl acetate copolymer, or a poly(vinyl acetate). Examples of the vinyl alcohol resin include a polyvinyl alcohol and an ethylene-vinyl alcohol copolymer.

The melting point of the thermoplastic resin (a11) is preferably from 70 to 180° C., and more preferably from 90 to 180° C. When the melting point of the thermoplastic resin (a11) is too high, adhesion with a layer of a rubber composition cannot be obtained at low temperature vulcanization. When the melting point of the thermoplastic resin (a11) is too low, the dimensions of an inner liner may not be maintained when placed in an environment with a high temperature, such as a vulcanization process, in a process of manufacturing a tire.

The thermoplastic elastomer (a12) which has a melting point of not higher than 180° C. and does not comprise a residue containing an unsaturated bond derived from a conjugated diene compound (hereinafter, simply referred to as “thermoplastic elastomer (a12)”) is preferably, but not limited to, a polyester elastomer or a polyamide elastomer.

The polyester elastomer is a thermoplastic elastomer in which the hard segment is a polyester (for example, a polybutylene terephthalate) and the soft segment is a polyether (for example, a polytetramethylene glycol) or a polyester (for example, an aliphatic polyester). Polyester elastomers are commercially available, and commercial products can be used in the present invention. Examples of commercially available polyester elastomers include PERPRENE®, manufactured by Toyobo Co., Ltd. and HYTREL® manufactured by Toray DuPont Co., Ltd.

The polyamide elastomer is a thermoplastic elastomer in which the hard segment is a polyamide (for example, nylon 6, nylon 66, nylon 11, nylon 12) and the soft segment is a polyether (for example, a polyethylene glycol, a polypropylene glycol). Polyamide elastomers are commercially available, and commercial products can be used in the present invention. Examples of commercially available polyamide elastomers include UBESTA® XPA series manufactured by Ube Industries, Ltd. and PEBAX® manufactured by Arkema.

The melting point of the thermoplastic elastomer (a12) is preferably from 70 to 180° C., and more preferably from 90 to 180° C. When the melting point of the thermoplastic elastomer (a12) is too high, adhesion to a layer of a rubber composition cannot be obtained at low temperature vulcanization. When the melting point of the thermoplastic elastomer (a12) is too low, the dimensions of the inner liner may not be maintained when placed in an environment with a high temperature, such as a vulcanization process, in a process of manufacturing a tire.

The content of the thermoplastic resin (a11) or the thermoplastic elastomer (a12) in the thermoplastic elastomer composition is preferably from 20 to 70% by volume, more preferably from 25 to 65% by volume, and still more preferably from 30 to 60% by volume, based on the total amount of all polymer components in the thermoplastic elastomer composition. When the content of the thermoplastic resin (a11) or the thermoplastic elastomer (a12) is too low, the processability when melt-extruding a film or a sheet deteriorates.

When the thermoplastic elastomer composition comprises both the thermoplastic resin (a11) and the thermoplastic elastomer (a12), the total content of the thermoplastic resin (a11) and the thermoplastic elastomer (a12) may be from 20 to 70% by volume, based on the total amount of all polymer components in the thermoplastic elastomer composition. Here, the polymer components at least include a polymer such as a resin, elastomer, or rubber.

The thermoplastic elastomer composition preferably further comprises at least 2% by volume, based on the total amount of all polymer components in the thermoplastic elastomer composition, of a thermoplastic resin (a13) having a melting point of not lower than 200° C. or a thermoplastic elastomer (a14) which has a melting point of not lower than 200° C. and does not comprise a residue containing an unsaturated bond derived from a conjugated diene compound. When the thermoplastic elastomer composition includes the thermoplastic resin (a13) having a melting point of not lower than 200° C. or the thermoplastic elastomer (a14) which has a melting point of not lower than 200° C. and does not comprise a residue containing an unsaturated bond derived from a conjugated diene compound, the heat resistance of the thermoplastic elastomer composition is improved, and vulcanization failures such as foaming and dimensional changes during vulcanization can be suppressed.

Examples of the thermoplastic resin having a melting point of not lower than 200° C. (a13) (hereinafter, simply referred to as “thermoplastic resin (a13)”) include polybutylene terephthalate, polyethylene terephthalate, polytrimethylene terephthalate, polyethylene naphthalate, polybutylene naphthalate, nylon 6, nylon 66, nylon 610, nylon 612, nylon 46, nylon 6T, nylon 9T, nylon MXD6, and polylactic acid, and preferably, the resin is polybutylene terephthalate.

The melting point of the thermoplastic resin (a13) is preferably from 200 to 300° C., and more preferably from 200 to 280° C.

Examples of the thermoplastic elastomer (a14) which has a melting point of not lower than 200° C. and does not comprise a residue containing an unsaturated bond derived from a conjugated diene compound (hereinafter, simply referred to as “thermoplastic elastomer (a14)”) include a polyester elastomer having a melting point of not lower than 200° C. Preferably, the elastomer is a polybutylene terephthalate elastomer or a polybutylene naphthalate elastomer.

The melting point of the thermoplastic elastomer (a14) is preferably from 200 to 300° C., and more preferably from 200 to 280° C.

The content of the thermoplastic resin (a13) or the thermoplastic elastomer (a14) having a melting point of not lower than 200° C. in the thermoplastic elastomer composition is preferably not less than 2% by volume, more preferably 3 to 30% by volume, and still more preferably 4 to 25% by volume, based on the total amount of all polymer components in the thermoplastic elastomer composition. When the content of the thermoplastic resin (a13) or the thermoplastic elastomer (a14) is too small, the heat resistance of the thermoplastic elastomer composition is not sufficiently improved. When the content of the thermoplastic resin (a13) or the thermoplastic elastomer (a14) is too high, sufficient adhesion to a diene rubber composition may not be obtained.

When the thermoplastic elastomer composition comprises both the thermoplastic resin (a13) and the thermoplastic elastomer (a14), the total content of the thermoplastic resin (a13) and the thermoplastic elastomer (a14) may be not less than 2% by volume, based on the total amount of all polymer components in the thermoplastic elastomer composition.

The thermoplastic elastomer composition comprises an elastomer (a2) comprising a residue containing an unsaturated bond derived from a conjugated diene compound. The residue containing an unsaturated bond derived from a conjugated diene compound means a residue containing an unsaturated bond derived from a conjugated diene compound that is a constituent unit of a thermoplastic elastomer and that can be co-crosslinked with a diene rubber. Examples of the residue containing an unsaturated bond derived from 1,3-butadiene include —CH₂CH=CHCH₂— or —CH₂CH(—CH═CH₂)—. The elastomer (a2) comprising a residue containing an unsaturated bond derived from a conjugated diene compound (hereinafter, also simply referred to as “elastomer (a2)”) preferably includes, but is not limited to, a copolymer of a vinyl aromatic compound and a conjugated diene compound, and a partially hydrogenated product of the copolymer. Examples of the copolymer of a vinyl aromatic compound and a conjugated diene compound include a styrene-butadiene-styrene block copolymer (SBS), a styrene-isoprene-styrene block copolymer (SIS), and styrene-butadiene rubber (SBR).

The elastomer (a2) comprising a residue containing an unsaturated bond derived from a conjugated diene compound preferably contains an acid anhydride group or an epoxy group. The presence of an acid anhydride group or an epoxy group allows chemical interaction with the thermoplastic resin (a11) or the thermoplastic elastomer (a12), which makes it easier for the two to mix uniformly and reinforces the interface, thereby improving the mechanical property such as elongation or stress. Examples of the copolymer of a vinyl aromatic compound containing an acid anhydride group and a conjugated diene compound include maleic anhydride-modified SBS, maleic anhydride-modified SIS, and maleic anhydride-modified SBR. Examples of the copolymer of a vinyl aromatic compound containing an epoxy group and a conjugated diene compound include epoxy-modified SBS, epoxy-modified SIS, and epoxy-modified SBR.

The content of the elastomer (a2) comprising a residue containing an unsaturated bond derived from a conjugated diene compound in the thermoplastic elastomer composition is preferably from 30 to 80% by volume, more preferably from 35 to 75% by volume, and still more preferably from 40 to 70% by volume, based on the total amount of all polymer components in the thermoplastic elastomer composition. When the content of the elastomer (a2) is too small, sufficient adhesion to a diene rubber composition may not be obtained. When the content of elastomer (a2) is too large, the processability of melt extrusion of the thermoplastic elastomer composition into a film or sheet deteriorates.

The thermoplastic elastomer composition may comprise a polymer or polymers other than the thermoplastic resin (a11) having a melting point of not higher than 180° C., the thermoplastic elastomer (a12) which has a melting point of not higher than 180° C. and does not comprise a residue of an unsaturated bond derived from a conjugated diene compound, the thermoplastic resin (a13) having a melting point of not lower than 200° C. and the thermoplastic elastomer (a14) which has a melting point of not lower than 200° C. and does not comprise a residue containing an unsaturated bond derived from a conjugated diene compound, and the elastomer (a2) comprising a residue containing an unsaturated bond derived from a conjugated diene compound, and a variety of additives, to the extent that they do not inhibit an effect of the invention.

On the surface of the inner liner of the present invention, the elastomer (a2) comprising a residue containing an unsaturated bond derived from a conjugated diene compound in the thermoplastic elastomer composition is exposed, and the ratio of the exposed area is not less than 5% of the surface area of the inner liner. The ratio of the exposed area of the elastomer (a2) comprising a residue containing an unsaturated bond derived from a conjugated diene compound is preferably from 5 to 100%, more preferably from 8 to 95%, and still more preferably from 10 to 90%. When the ratio of the exposed area is too small, the thermoplastic elastomer composition and the rubber composition may not be sufficiently bonded. When the ratio is too large, the tackiness of the thermoplastic elastomer composition is too strong during the tire molding process, resulting in poor handling properties. The ratio of the exposed area can be calculated from a morphology image obtained by atomic force microscopy. The exposed area can be controlled by conditions for kneading the thermoplastic elastomer composition or the volume ratio and the melt viscosity ratio of the elastomer (a2) comprising a residue containing an unsaturated bond derived from a conjugated diene compound to other polymer components in the thermoplastic elastomer composition, and when the volume ratio of the elastomer (a2) comprising a residue containing an unsaturated bond derived from a conjugated diene compound to the all polymer components is high and the melt viscosity ratio at the kneading temperature is large, the exposed area tends to be large.

The tensile elongation at break of the thermoplastic elastomer composition at a temperature of 25° C. and a pull speed of 500 mm/min is not less than 100%, preferably from 150 to 1,000%, and still more preferably from 200 to 800%. When the tensile elongation at break is in the above-described numerical range, the elastomer is able to follow deformation applied to an inner liner during tire molding, and is able to follow deformation during tire rolling. The tensile elongation at break is measured in accordance with JIS K6301 “Physical Test Method for Vulcanized Rubber”.

The thickness of the inner liner is not limited as long as the inner liner has a necessary air permeation prevention performance, and is preferably from 10 to 500 μm, more preferably from 20 to 400 μm, and still more preferably from 30 to 300 μm. When the thickness of the inner liner is too thin, the inner liner tends to wrinkle when laminated with rubber on a tire molding machine, and the handling properties may deteriorate. When the thickness of the inner liner is too thick, the tire cannot be made sufficiently lightweight.

The method of manufacturing the inner liner of the present invention is not limited, and for example, the inner liner of the present invention can be manufactured by melt-kneading a composition comprising the thermoplastic resin (a11) having a melting point of not higher than 180° C. or the thermoplastic elastomer (a12) which has a melting point of not higher than 180° C. and does not comprise a residue containing an unsaturated bond derived from a conjugated diene compound and the elastomer (a2) comprising a residue containing an unsaturated bond derived from a conjugated diene compound, or a composition obtained by blending the above composition with the thermoplastic resin (a13) having a melting point of not lower than 200° C. or the thermoplastic elastomer (a14) which has a melting point of not lower than 200° C. and does not comprise a residue of an unsaturated bond derived from a conjugated diene compound, other polymers, and a variety of additives as necessary, and forming the melt-kneaded product into a sheet by a forming method such as a T-die extrusion forming method or an inflation forming method.

The present invention (II) relates to a laminate of a layer of a thermoplastic elastomer composition and a layer of a rubber composition.

The thermoplastic elastomer composition constituting the layer of the thermoplastic elastomer composition comprises the thermoplastic resin (a11) having a melting point of not higher than 180° C. or the thermoplastic elastomer (a12) which has a melting point of not higher than 180° C. and does not comprise a residue containing an unsaturated bond derived from a conjugated diene compound and the elastomer (a2) comprising a residue containing an unsaturated bond derived from a conjugated diene compound, and the thermoplastic elastomer composition has a tensile elongation at break at a temperature of 25° C. and a pull speed of 500 mm/min of not less than 100%. The thermoplastic elastomer composition constituting the layer of the thermoplastic elastomer composition can be the same as the thermoplastic elastomer composition constituting the inner liner of the present invention (I).

The rubber composition constituting the layer of the rubber composition comprises not less than 50% by volume of a diene rubber. By comprising not less than 50% by volume of a diene rubber, the layer of the rubber composition can bond to an adjacent tire member by co-vulcanization.

Examples of the diene rubber include a natural rubber (NR), an isoprene rubber (IR), a butadiene rubber (BR)(high-cis BR and low-cis BR), a styrene-butadiene rubber (SBR), a chloroprene rubber (CR), an acrylonitrile butadiene rubber (NBR), an epoxidized natural rubber, and a hydrogenated product thereof. The diene rubber is preferably at least one selected from the group consisting of a natural rubber, an isoprene rubber, a butadiene rubber, a styrene-butadiene rubber, a chloroprene rubber, and an acrylonitrile butadiene rubber.

The rubber composition may comprise a rubber other than a diene rubber.

The content of the diene rubber in the rubber composition is not less than 50% by volume, preferably 55 to 95% by volume, and more preferably 60 to 90% by volume, based on the rubber composition. When the content of the diene rubber is too low, sufficient adhesion to an adjacent tire member may not be obtained, and when the content of the diene rubber is too high, sufficient adhesion to a thermoplastic elastomer composition may not be obtained.

In addition to a rubber, the rubber composition can comprise a variety of additives typically used in manufacturing tires, such as a reinforcing agent (filler), a vulcanizing agent (cross-linking agent), a vulcanization accelerating aid, a vulcanization accelerator, an anti-scorch agent, an anti-aging agent, a kneading accelerator, an organic modifier, a softening agent, a plasticizer, and an adhesive agent.

In the laminate of the present invention, a layer of a thermoplastic elastomer composition and a layer of a rubber composition are adjacent to each other. Here, “adjacent” means that the layer of the thermoplastic elastomer composition and the layer of the rubber composition are in direct contact with each other, and that there is no other layer between the layer of the thermoplastic elastomer composition and the layer of the rubber composition. Despite the fact that the laminate of the present invention does not comprise a layer of an adhesive or adhesive tie-rubber, and despite the fact that the layer of the rubber composition does not comprise an adhesive, the layer of the thermoplastic elastomer composition and the layer of the rubber composition bond to each other by vulcanization at a low temperature of about 160° C.

In the laminate of the present invention, at the interface between the layer of the thermoplastic elastomer composition and the layer of the rubber composition, the elastomer (a2) comprising a residue containing an unsaturated bond derived from a conjugated diene compound in the layer of the thermoplastic elastomer composition is in contact with the layer of the rubber composition, and the ratio of the contact area is not less than 5% with respect to the total contact area of the layer of the thermoplastic elastomer composition and the layer of the rubber composition. The ratio of the contact area of the elastomer (a2) comprising a residue containing an unsaturated bond derived from a conjugated diene compound and the rubber composition is preferably from 5 to 100%, more preferably from 8 to 95%, and still more preferably from 10 to 90%. When the ratio of the contact area is too small, the thermoplastic elastomer composition and the rubber composition may not be sufficiently bonded. When the ratio is too large, the tackiness becomes too strong when the thermoplastic elastomer composition and the rubber composition are laminated in the process of tire molding, resulting in inability to make corrections such as reattachment, and worsening of handling properties. The ratio of the contact area can be calculated from a morphology image obtained by atomic force microscopy. The contact area can be controlled by conditions for kneading the thermoplastic elastomer composition or the volume ratio and the melt viscosity ratio of the elastomer (a2) comprising a residue containing an unsaturated bond derived from a conjugated diene compound to the other polymer components in the thermoplastic elastomer composition. When the volume ratio of the elastomer (a2) comprising a residue containing an unsaturated bond derived from a conjugated diene compound to the all polymer components is high, and the melt viscosity ratio at the kneading temperature is large, the elastomer (a2) comprising a residue containing an unsaturated bond derived from a conjugated diene compound tends to be exposed and the contact area tends to be large.

The thickness of the layer of the thermoplastic elastomer composition is not limited as long as the layer of the thermoplastic elastomer composition has a necessary air permeation prevention performance, and the thickness is preferably from 10 to 500 μm, more preferably from 20 to 400 μm, and still more preferably from 30 to 300 μm. When the thickness of the layer of the thermoplastic elastomer composition is too thin, the layer tends to wrinkle when laminated with rubber on a tire molding machine, and handling properties may deteriorate. When the thickness of the layer of the thermoplastic elastomer composition is too thick, the weight of a tire cannot be reduced sufficiently.

The thickness of the layer of the rubber composition is preferably from 0.1 to 10.0 mm, more preferably from 0.15 to 8.0 mm, and still more preferably from 0.2 to 6.0 mm. When the thickness of the layer of the rubber composition is too thin, the layer tends to wrinkle when laminated with the thermoplastic elastomer composition, and the handling properties may deteriorate. When the thickness of the layer of the rubber composition is too thick, the weight of a tire cannot be reduced sufficiently.

The laminate of the present invention functions as an inner liner when integrated into a pneumatic tire.

A method for manufacturing the laminate of the present invention is not limited, but it can be manufactured, for example, as follows. A sheet of the thermoplastic elastomer composition is produced by melt-kneading a composition comprising the thermoplastic resin (a11) having a melting point of not higher than 180° C. or the thermoplastic elastomer (a12) which has a melting point of not higher than 180° C. and does not comprise a residue containing an unsaturated bond derived from a conjugated diene compound and the elastomer (a2) containing a residue containing an unsaturated bond derived from a conjugated diene compound, or a composition obtained by blending the above composition with the thermoplastic resin (a13) having a melting point of not lower than 200° C. or the thermoplastic elastomer (a14) which has a melting point of not lower than 200° C. and does not comprise a residue derived from a conjugated diene compound, other polymers, and a variety of additives as necessary, and forming it into a sheet by a forming method such as a T-die extrusion forming method or an inflation forming method to prepare a sheet of the thermoplastic elastomer composition. Separately, a variety of additives are blended with a diene rubber and mixed using a Banbury mixer or the like to prepare a rubber composition, and the rubber composition is calendered and formed into a sheet to produce a sheet of a rubber composition. By overlapping the produced sheet of the thermoplastic elastomer composition and the produced sheet of the rubber composition, a laminate is obtained.

The present invention (III) is a pneumatic tire comprising the inner liner of the present invention (I) or the laminate of the present invention (H).

When the pneumatic tire comprises the laminate of the present invention (II), a carcass layer may constitute the layer of the rubber composition of the laminate of the present invention (II).

The pneumatic tire of the present invention (III) can be manufactured by a usual method. For example, the inner liner of the invention (I) or the laminate of the present invention (II) is placed on a drum for tire molding, and on top thereof, members used in usual tire manufacturing, such as a carcass layer, a belt layer, a tread layer, and the like, which are made of unvulcanized rubber, are sequentially stacked, and molded, and thereafter the drum is pulled out to obtain a green tire, and then the green tire is heat-vulcanized according to a usual method, thereby manufacturing a pneumatic tire.

### EXAMPLES

### (1) Raw Materials

Raw materials used in the following Examples and Comparative Examples are as follows.

Nylon 11: “RILSAN” BESN O 0TL manufactured by Arkema and having a melting point of 187° C.

Nylon 6/66: Nylon 6/66 copolymer “UBE NYLON®” 5023B manufactured by Ube Industries, Ltd. and having a melting point of 197° C.

EVOH 1: Ethylene vinyl alcohol copolymer “SoarnoL®” H4815B manufactured by The Nippon Synthetic Chemical Industry Co., Ltd. and having a melting point of 158° C.

EVOH 2: Ethylene-vinyl alcohol copolymer “SoarnoL®” E3808 manufactured by The Nippon Synthetic Chemical Industry Co., Ltd. and having a melting point of 173° C.

EVA: Ethylene-vinyl acetate copolymer “NOVATECH®” EVA LV211A manufactured by Japan Polyethylene Corporation and having a melting point of 103° C.

Partially saponified EVA: Partially saponified ethylene-vinyl acetate copolymer “MERSEN®” H6410M manufactured by Tosoh Corporation and having a melting point of 100° C.

PP: Polypropylene “PrimePolypro®” E-333GV manufactured by Prime Polymer Co., Ltd. and having a melting point of 160° C.

Polyamide elastomer: “UBESTA®” XPA 9040X1 manufactured by Ube Industries, Ltd. and having a melting point of 135° C.

PBT Elastomer 1: Polybutylene terephthalate elastomer “PERPRENE®” P-75M manufactured by TOYOBO CO., LTD. and having a melting point of 155° C.

PBT Elastomer 2: Polybutylene terephthalate elastomer “PERPRENE®” P-30B manufactured by TOYOBO CO., LTD. and having a melting point of 160° C.

PBT Elastomer 3: Polybutylene terephthalate elastomer “PERPRENE®” P-40H manufactured by TOYOBO CO., LTD. and having a melting point of 172° C.

PBT Elastomer 4: Polybutylene terephthalate elastomer “PERPRENE®” P150B manufactured by TOYOBO CO., LTD. and having a melting point of 212° C.

PBT: Polybutylene terephthalate “NOVADURAN®” 5010R5 manufactured by Mitsubishi Engineering-Plastics Corporation and having a melting point of 225° C.

Acid-modified SBS: Maleic anhydride-modified styrene-butadiene-styrene block copolymer “TUFPRENE®” 912 manufactured by Asahi Kasei Chemicals Corporation

Epoxy-modified SBS 1: Epoxy-modified styrene-butadiene-styrene block copolymer “EPOFRIEND®” AT501 manufactured by Daicel Corporation.

Epoxy-modified SBS 2: Epoxy-modified styrene-butadiene-styrene block copolymer “EPOFRIEND®” CN310 manufactured by Daicel Corporation.

Acid-modified PO: Maleic anhydride-modified polyoletin elastomer “TAFMER®” MH7020 manufactured by Mitsui Chemicals, Inc.

### (2) Preparation of Thermoplastic Elastomer Composition

With the formulations shown in Tables 1 to 3, the raw materials were introduced into a twin-screw extruder manufactured by The Japan Steel Works, LTD., which was set at a cylinder temperature 20° C. higher than the melting point of the raw material having the highest melting point among the polymer components, and transported to a kneading zone set at a residence time of approximately 3 to 6 minutes for melt-kneading, and the melt-kneaded product was extruded in the form of a strand from a die attached to a discharge port. The resulting stranded extrudate was pelletized using a resin pelletizer to obtain a pelleted thermoplastic elastomer composition.

### (3) Production of Sheet of Thermoplastic Elastomer Composition

The pelleted thermoplastic elastomer composition prepared by the above-described procedure (2) was molded into a sheet having an average thickness of 0.1 mm using a40 mmφ single-screw extruder with a 200 mm wide T-type die (Pla Giken Co., Ltd.), with the temperature of a cylinder and a die set to a temperature 10° C. higher than the melting point of the material having the highest melting point in the composition, under the extrusion conditions of cooling roll temperature of 50° C. and take-up speed of 3 m/min, to produce a sheet of the thermoplastic elastomer composition i.e., inner liner.

### (4) Preparation of Rubber Composition and Production of Sheet

The raw rubber and a variety of compounding agents were fed into a closed-type Banbury mixer according to the formulations described in Table 4, and mixed. The resulting rubber composition was processed into a sheet of 2 mm thickness using a roll for rubber to produce a sheet of the rubber composition.

### (5) Production of Laminate

The sheet of the thermoplastic elastomer composition produced in the above-described (3) and the sheet of the rubber composition produced in the above-described (4) were cut out to a size having a length of 15 cm and a width of 15 cm, and laminated to produce a laminate.

### (6) Measurement of Tensile Elongation at Break of Thermoplastic Elastomer Compositions

The sheet of the thermoplastic elastomer composition produced in the above-described (3) was punched into a JIS No. 3 dumbbell shape, and a tensile test was conducted at a temperature of 25° C. and a pull speed of 500 mm/min in accordance with JIS K6301 “Vulcanized Rubber Physical Test Method”. The tensile elongation at break was determined from the stress strain curve obtained. Sheets were graded as “Unacceptable” when the tensile elongation at break was less than 100%, “Acceptable” when the elongation was not less than 100% and less than 200%, “Good” when the elongation was not less than 200% and less than 300%, and “Excellent” when the elongation was not less than 3000%. The results are shown in Tables 1 to 3. “Excellent”, “Good”, and “Acceptable” can be used as tire members.

### (7) Confirmation of Surface of Thermoplastic Elastomer Composition

The sheet of the thermoplastic elastomer composition produced in the above-described (3) was cut out, and the surface of the sheet was observed with an atomic force microscope (AFM). A scanning was performed by controlling a sample and the distance from the sample in a force curve mapping mode, and a mapping image of the elastic modulus was obtained from the force applied to the cantilever. Since the elastomer (a2) comprising a residue containing an unsaturated bond derived from a conjugated diene compound in the thermoplastic elastomer composition has a different elastic modulus from the thermoplastic resin (a11) and the elastomer (a12) which does not comprise a residue containing an unsaturated bond derived from a conjugated diene compound and can be identified as different phases, the exposed ratio of the elastomer (a2) comprising a residue containing an unsaturated bond derived from a conjugated diene compound was determined by calculating the area ratio of the obtained image by image analysis. Ten locations were randomly selected and observed in a field of view of 30 μm×30 μm, and the average value was employed.

### (8) Measurement of Bond Strength

The sheet of the rubber composition produced in the above-described (4) was laminated on the sheet of the thermoplastic elastomer composition produced in the above-described (3), and vulcanization bonding was performed at a pressure of 2.3 MPa and at 160° C. for 20 minutes in a press molding machine. The obtained laminate was cut into strips of 25 mm width, and a peeling test was conducted by pulling the test pieces at an angle of 180° at 25° C. at a peeling speed of 500 mm/min to measure the bond strength in terms of N/25 mm. The results are shown in Tables 1 to 3. When the bond strength is less than 20 N/25 mm, the laminate cannot be used as a tire component because of peeling during tire rolling, and when the adhesive strength is not less than 20 N/25 mm, the laminate can be used.

### (9) Confirmation of Contact State in Laminate

A portion of the vulcanized laminate produced in the above-described (8) was cut out, and the laminate was cut with a microtome while cooled with liquid nitrogen to expose a smooth section, and observation was performed with an atomic force microscope (AFM). In the section of the laminate, the interface where the elastomer (a2) comprising a residue containing an unsaturated bond derived from a conjugated diene compound in the thermoplastic elastomer composition and the rubber composition do not come into contact is L1, and the interface where they do is L2, and L2/(L1+L2) was determined as the contact ratio. Ten locations were randomly extracted and observed in a 30 μm×30 μm field of view, and the average value was employed.

TABLE 1

| | | Compar- | Compar- | | | | | |
|---|---|---|---|---|---|---|---|---|
| | | ative | ative | Exam- | Exam- | Exam- | Exam- | Exam- |
| | | Example 1 | Example 2 | ple 1 | ple 2 | ple 3 | ple 4 | ple 5 |
| Nylon 11 having a melting point of 187° C. | parts by volume | 34 | | | | | | |
| Nylon 6/66 having a melting point of 197° C. | parts by volume | 14 | 25 | 15 | | | | |
| EVOH 1 having a melting point of 158° C. | parts by volume | | | 25 | 35 | 45 | | 35 |
| EVOH 2 having a melting point of 173° C. | parts by volume | | | | | | 45 | |
| EVA having a melting point of 103° C. | parts by volume | | | | | | | |
| Partially saponified EVA (having a melting | parts by volume | | | | | | | |
| point of 100° C. | | | | | | | | |
| PP having a melting point of 160° C. | parts by volume | | | | | | | |
| Polyamide elastomer having a melting point | parts by volume | | | | | | | |
| of 135° C. | | | | | | | | |
| PBT elastomer 1 having a melting point of 155° C. | parts by volume | | | | | | | |
| PBT elastomer 2 having a melting point of 160° C. | parts by volume | | | | | | | |
| PBT elastomer 3 having a melting point of 172° C. | parts by volume | | | | | | | |
| PBT elastomer 4 having a melting point of 212° C. | parts by volume | | | | | | | |
| PBT having a melting point of 225° C. | parts by volume | | | | 5 | 5 | 5 | 5 |
| Acid-modified SBS | parts by volume | | | | | 50 | | |
| Epoxy-modified SBS 1 | parts by volume | 20 | 60 | 60 | 60 | | 50 | 35 |
| Epoxy-modified SBS 2 | parts by volume | | | | | | | |
| Acid-modified PO | parts by volume | 32 | 15 | | | | | 25 |
| Tensile elongation at break | % | Good | Accept- | Excel- | Excel- | Good | Excel- | Good |
| | | | able | lent | lent | | lent | |
| Exposed rate of Elastomer (a2) | % | 0 | 2 | 16 | 55 | 46 | 67 | 20 |
| Contact rate of Elastomer (a2) in Laminate | % | 0 | 2 | 16 | 59 | 46 | 70 | 21 |
| Bond strength | N/25 mm | 10 | | 40 | 110 | 60 | 70 | 80 |

TABLE 2

| | | Exam- | Exam- | Exam- | Comparative | Exam- | Exam- | Exam- |
|---|---|---|---|---|---|---|---|---|
| | | ple 6 | ple 7 | ple 8 | Example 3 | ple 9 | ple 10 | ple 11 |
| Nylon 11 having a melting point of 187° C. | parts by volume | | | | | | | |
| Nylon 6/66 having a melting point of 197° C. | parts by volume | | | | | | | |
| EVOH 1 having a melting point of 158° C. | parts by volume | 40 | | | | | | |
| EVOH 2 having a melting point of 173° C. | parts by volume | | | | | | | |
| EVA having a melting point of 103° C. | parts by volume | | 40 | | | | | |
| Partially saponified EVA having a melting point | parts by volume | | | 40 | | | | |
| of 100° C. | | | | | | | | |
| PP having a melting point of 160° C. | parts by volume | | | | 55 | | | |
| Polyamide elastomer having a melting point of 135° C. | parts by volume | | | | | 55 | | |
| PBT elastomer 1 having a melting point of 155° C. | parts by volume | | | | | | 55 | |
| PBT elastomer 2 having a melting point of 160° C. | parts by volume | | | | | | | 55 |
| PBT elastomer 3 having a melting point of 172° C. | parts by volume | | | | | | | |
| PBT elastomer 4 having a melting point of 212° C. | parts by volume | | | | | | | |
| PBT having a melting point of 225° C. | parts by volume | 10 | 10 | 10 | 5 | 5 | 5 | 5 |
| Acid-tnodified SBS | parts by volume | | 40 | 40 | | | | |
| Epoxy-modified SBS1 | parts by volume | 50 | | | 40 | 40 | 40 | 40 |
| Epoxy-modified SBS2 | parts by volume | | | | | | | |
| Acid-modified PO | parts by volume | | 10 | 10 | | | | |
| Tensile elongation at break | % | Excel- | Accept- | Accept- | Unacceptable | Good | Excel- | Excel- |
| | | lent | able | able | | | lent | lent |
| Exposed rate of Elastomer (a2) | % | 21 | 32 | 33 | 10 | 31 | 45 | 35 |
| Contact rate of Elastomer (a2) in Laminate | % | 22 | 35 | 34 | 11 | 34 | 49 | 38 |
| Bond strength | N/25 mm | 90 | 65 | 70 | 40 | 90 | 100 | 80 |

TABLE 3

| | | Exam- | Comparative | Exam- | Exam- | Exam- | Comparative |
|---|---|---|---|---|---|---|---|
| | | ple 12 | Example 4 | ple 13 | ple 14 | ple 15 | Example 5 |
| Nylon 11 having a melting point of 187° C. | parts by volume | | | | | | |
| Nylon 6/66 having a melting point of 197° C. | parts by volume | | | | | | |
| EVOH 1 having a melting point of 158° C. | parts by volume | | | 60 | 20 | 30 | 10 |
| EVOH 2 having a melting point of 173° C. | parts by volume | | | | | | |
| EVA having a melting point of 103° C. | parts by volume | | | | | | |
| Partially saponified EVA having a melting point | parts by volume | | | | | | |
| of 100° C. | | | | | | | |
| PP having a melting point of 160° C. | parts by volume | | | | | | |
| Polyamide elastomer having a melting point of 135° C. | parts by volume | | | | | | |
| PBT elastomer 1 having a melting point of 155° C. | parts by volume | | | | | | |
| PBT elastomer 2 having a melting point of 160° C. | parts by volume | | | | | | |
| PBT elastomer 3 having a melting point of 172° C. | parts by volume | 55 | | | | | |
| PBT elastomer 4 having a melting point of 212° C. | parts by volume | | 55 | 10 | | | |
| PBT having a melting point of 225° C. | parts by volume | 5 | 5 | | 20 | 20 | 40 |
| Acid- modified SBS | parts by volume | | | | | | |
| Epoxy-modified SBS 1 | parts by volume | 40 | 40 | | 60 | 50 | 50 |
| Epoxy-modified SBS 2 | parts by volume | | | 30 | | | |
| Acid-modified PO | parts by volume | | | | | | |
| Tensile elongation at break | % | Excellent | Excellent | Excellent | Acceptable | Good | Good |
| Exposed rate of Elastomer (a2) | % | 30 | 3 | 12 | 80 | 60 | 2 |
| Contact rate of Elastomer (a2) in Laminate | % | 33 | 3 | 13 | 84 | 67 | 2 |
| Adhesive strength | N/25 mm | 55 | 15 | 35 | 140 | 80 | 10 |

TABLE 4

| Raw | | parts |
|---|---|---|
| materials | Brand name Manufacturer | by mass |
| Natural rubber | PT. NUSIRA SIR20 | 50 |
| Emulsion- | NIPOL ® 1502 manufactured by Zeon | 30 |
| polymerized | Corporation | |
| SBR | | |
| Polybutadiene | NIPOL ® BR 1220 manufactured by Zeon | 20 |
| rubber | Corporation | |
| Carbon black | Show Black N339 manufactured by Cabot | 60 |
| | Japan K. K. | |
| Process Oil | Extra No. 4 S manufactured by SHOWA | 5 |
| | SHELL SEKIYU K. K. | |
| Sulfur | Oil processing sulfur manufactured by HOSOI | 3 |
| | CHEMICAL INDUSTRY CO., LTD. | |
| Vulcanization | Noxeller ® NS-P manufactured by OUCHI | 1 |
| accelerator | SHINKO CHEMICAL INDUSTRIAL CO., | |
| | LTD. | |

### INDUSTRIAL APPLICABILITY

The inner liner of the present invention can be suitably used for manufacturing a pneumatic tire.

1. An inner liner for a pneumatic tire comprising a thermoplastic elastomer composition, wherein the thermoplastic elastomer composition comprises: a thermoplastic resin (a11) having a melting point of not higher than 180° C. or a thermoplastic elastomer (a12) which has a melting point of not higher than 180° C. and does not comprise a residue containing an unsaturated bond derived from a conjugated diene compound; and an elastomer (a2) comprising a residue containing an unsaturated bond derived from a conjugated diene compound, and wherein the thermoplastic elastomer composition has a tensile elongation at break at a temperature of 25° C. and a pull speed of 500 mm/min of not less than 100%.

2. The inner liner according to claim 1, wherein the thermoplastic resin (a11) having a melting point of not higher than 180° C. or the thermoplastic elastomer (a12) which has a melting point of not higher than 180° C. and does not comprise a residue containing an unsaturated bond derived from a conjugated diene compound is at least one selected from the group consisting of a vinyl alcohol resin, an ethylene-vinyl acetate copolymer, a poly(vinyl acetate), a polyester elastomer, and a polyamide elastomer.

3. The inner liner according to claim 1, wherein the elastomer (a2) comprising a residue containing an unsaturated bond derived from a conjugated diene compound is a copolymer of a vinyl aromatic compound having an acid anhydride group or epoxy group and a conjugated diene compound, or a partially hydrogenated product of the copolymer.

4. The inner liner according to claim 1, wherein the thermoplastic elastomer composition further comprises at least 2% by volume, based on the total amount of all polymer components in the thermoplastic elastomer composition, of a thermoplastic resin (a13) having a melting point of not lower than 200° C. or a thermoplastic elastomer (a4) which has a melting point of not lower than 200° C. and does not comprise a residue containing an unsaturated bond derived from a conjugated diene compound.

5. The inner liner according to claim 1, wherein the content of the thermoplastic resin (a11) having a melting point of not higher than 180° C., or the thermoplastic elastomer (a12) which has a melting point of not higher than 180° C. and does not comprise a residue containing an unsaturated bond derived from a conjugated diene compound is from 20 to 70% by volume based on the total amount of all polymer components in the thermoplastic elastomer composition, and the content of the elastomer (a2) comprising a residue containing an unsaturated bond derived from a conjugated diene compound is from 30 to 80% by volume based on the total amount of all polymer components in the thermoplastic elastomer composition.

6. The inner liner according to claim 1, wherein the elastomer (a2) comprising a residue containing an unsaturated bond derived from a conjugated diene compound is exposed on the surface of the inner liner, and the ratio of the exposed area is not less than 5% of the surface area of the inner liner.

7. A laminate of a layer of a thermoplastic elastomer composition and a layer of a rubber composition, wherein the thermoplastic elastomer composition comprises: a thermoplastic resin (a11) having a melting point of not higher than 180° C. or a thermoplastic elastomer (a12) which has a melting point of not higher than 180° C. and does not comprise a residue containing an unsaturated bond derived from a conjugated diene compound; and an elastomer (a2) comprising a residue containing an unsaturated bond derived from a conjugated diene compound, wherein the thermoplastic elastomer composition has a tensile elongation at break at a temperature of 25° C. and a pull speed of 500 mm/min of not less than 100%, and wherein the rubber composition comprises not less than 50% by volume of a diene rubber, and the layer of the thermoplastic elastomer composition and the layer of the rubber composition are adjacent to each other.

8. The laminate according to claim 7, wherein the diene rubber is at least one selected from the group consisting of a natural rubber, an isoprene rubber, a butadiene rubber, a styrene-butadiene rubber, a chloroprene rubber, and an acrylonitrile butadiene rubber.

9. The laminate according to claim 7, wherein at the interface between the layer of the thermoplastic elastomer composition and the layer of the rubber composition, the elastomer (a2) comprising a residue containing an unsaturated bond derived from a conjugated diene compound in the layer of the thermoplastic elastomer composition is in contact with the layer of the rubber composition, and the ratio of the contact area is not less than 5% of the total contact area of the layer of the thermoplastic elastomer composition and the layer of the rubber composition.

10. A pneumatic tire comprising the inner liner according to claim 1 or a laminate of a layer of a thermoplastic elastomer composition and a layer of a rubber composition, wherein the thermoplastic elastomer composition comprises: a thermoplastic resin (a11) having a melting point of not higher than 180° C. or a thermoplastic elastomer (a12) which has a melting point of not higher than 180° C. and does not comprise a residue containing an unsaturated bond derived from a conjugated diene compound; and an elastomer (a2) comprising a residue containing an unsaturated bond derived from a conjugated diene compound, wherein the thermoplastic elastomer composition has a tensile elongation at break at a temperature of 25° C. and a pull speed of 500 mm/min of not less than 100%, and wherein the rubber composition comprises not less than 50% by volume of a diene rubber, and the layer of the thermoplastic elastomer composition and the layer of the rubber composition are adjacent to each other.

11. The inner liner according to claim 2, wherein the elastomer (a2) comprising a residue containing an unsaturated bond derived from a conjugated diene compound is a copolymer of a vinyl aromatic compound having an acid anhydride group or epoxy group and a conjugated diene compound, or a partially hydrogenated product of the copolymer.

12. The inner liner according to claim 2, wherein the thermoplastic elastomer composition further comprises at least 2% by volume, based on the total amount of all polymer components in the thermoplastic elastomer composition, of a thermoplastic resin (a13) having a melting point of not lower than 200° C. or a thermoplastic elastomer (a14) which has a melting point of not lower than 200° C. and does not comprise a residue containing an unsaturated bond derived from a conjugated diene compound.

13. The inner liner according to claim 3, wherein the thermoplastic elastomer composition further comprises at least 2% by volume, based on the total amount of all polymer components in the thermoplastic elastomer composition, of a thermoplastic resin (a13) having a melting point of not lower than 200° C. or a thermoplastic elastomer (a14) which has a melting point of not lower than 200° C. and does not comprise a residue containing an unsaturated bond derived from a conjugated diene compound.

14. The inner liner according to claim 2, wherein the content of the thermoplastic resin (a11) having a melting point of not higher than 180° C., or the thermoplastic elastomer (a12) which has a melting point of not higher than 180° C. and does not comprise a residue containing an unsaturated bond derived from a conjugated diene compound is from 20 to 70% by volume based on the total amount of all polymer components in the thermoplastic elastomer composition, and the content of the elastomer (a2) comprising a residue containing an unsaturated bond derived from a conjugated diene compound is from 30 to 80% by volume based on the total amount of all polymer components in the thermoplastic elastomer composition.

15. The inner liner according to claim 3, wherein the content of the thermoplastic resin (a11) having a melting point of not higher than 180° C., or the thermoplastic elastomer (a12) which has a melting point of not higher than 180° C. and does not comprise a residue containing an unsaturated bond derived from a conjugated diene compound is from 20 to 70% by volume based on the total amount of all polymer components in the thermoplastic elastomer composition, and the content of the elastomer (a2) comprising a residue containing an unsaturated bond derived from a conjugated diene compound is from 30 to 80% by volume based on the total amount of all polymer components in the thermoplastic elastomer composition.

16. The inner liner according to claim 4, wherein the content of the thermoplastic resin (a11) having a melting point of not higher than 180° C., or the thermoplastic elastomer (a12) which has a melting point of not higher than 180° C. and does not comprise a residue containing an unsaturated bond derived from a conjugated diene compound is from 20 to 70% by volume based on the total amount of all polymer components in the thermoplastic elastomer composition, and the content of the elastomer (a2) comprising a residue containing an unsaturated bond derived from a conjugated diene compound is from 30 to 80% by volume based on the total amount of all polymer components in the thermoplastic elastomer composition.

17. The inner liner according to claim 2, wherein the elastomer (a2) comprising a residue containing an unsaturated bond derived from a conjugated diene compound is exposed on the surface of the inner liner, and the ratio of the exposed area is not less than 5% of the surface area of the inner liner.

18. The inner liner according to claim 3, wherein the elastomer (a2) comprising a residue containing an unsaturated bond derived from a conjugated diene compound is exposed on the surface of the inner liner, and the ratio of the exposed area is not less than 5% of the surface area of the inner liner.

19. The inner liner according to claim 4, wherein the elastomer (a2) comprising a residue containing an unsaturated bond derived from a conjugated diene compound is exposed on the surface of the inner liner, and the ratio of the exposed area is not less than 5% of the surface area of the inner liner.

20. The inner liner according to claim 5, wherein the elastomer (a2) comprising a residue containing an unsaturated bond derived from a conjugated diene compound is exposed on the surface of the inner liner, and the ratio of the exposed area is not less than 5% of the surface area of the inner liner.
